(19) United States
(12) Patent Application Publication
(10) Pub. No.: US 2009/0236119 A1
(43) Pub. Date: Sep. 24, 2009

(54) FINNED JACKET WITH CORE WRAP FOR USE IN LAN CABLES

(75) Inventor: Robert Wessels, JR., Hickory, NC (US)

Correspondence Address: CommScope by Muncy, Geissler, Olds & Lowe, PLLC, P.O. Box 1364, Fairfax, VA, 22038, US

(73) Assignee: CommScope, Inc. of North Carolina

(21) Appl. No.: 12/406,787

(22) Filed: Mar. 18, 2009

Related U.S. Application Data
(60) Provisional application No. 61/037,900, filed on Mar. 19, 2008.

(51) Int. Cl. H01B 11/02

(52) U.S. Cl. 174/113 AS

(57) ABSTRACT

A twisted pair cable includes a jacket having a plurality of projections extending away from an inner surface of the jacket to define a plurality of air channels along the inner surface of the jacket. A cable core, including four twisted wire pairs and possibly a separator, resides within the jacket. A core wrap at least partially surrounds the cable core, such that the core wrap abuts the projections and prevents any wire of the cable core from entering into one of the air channels. In a preferred embodiment, the core wrap is formed by a tape in a helix shape about the cable core, wherein the tape partially overlaps itself in forming the helix shape, the tape includes an adhesive layer, and the overlapped portions of the tape are attached to each other via the adhesive to form an airtight connection.

This application claims the benefit of U.S. Provisional Application No. 61/037,900, filed Mar. 19, 2008, the entire contents of which are herein incorporated by reference.

### BACKGROUND OF THE INVENTION

1. Field of the Invention

The present invention relates to communication cables. More particularly, the present invention relates to a twisted pair cable having a jacket with projections on an inner wall to provide air channels around a core of the twisted wire pairs, and to a structure to permit maximization of the air channel dimensions.

2. Description of the Related Art

Jackets with projections or fins on an inner wall of the jacket are known in the prior art. For example, U.S. Pat. No. 3,894,172, U.S. Pat. No. 5,796,046, U.S. Pat. No. 7,238,886, and U.S. publication 2005/0133246, each of which is herein incorporated by reference, show a cable having internal fins or projections.

### SUMMARY OF THE INVENTION

The applicant has appreciated one or more drawbacks of the cable designs of the prior art.

First, there is a general goal in the design to maximize the air channel size and minimize the fin size. The reason for the general goal is to include as much air as possible in the immediate vicinity of the cable core (twisted wire pairs—possibly with a tape or star separator) and to include as little jacket material (e.g., fins) in the immediate vicinity of the cable core. Air has a dielectric constant of approximately 1.0, whereas the jacket material may have a dielectric constant of approximately 2.0-4.0 depending upon the jacket material. For example, polyethylene can have a dielectric constant of 2.3 and FEP can have a dielectric constant of 2.1. Having a generally lower dielectric constant material, e.g., air, nearest to the cable core improves the electrical performance of the cable.

FIG. 1 shows a cross sectional view through the finned jacket cable of U.S. publication 2005/0133246. As shown in FIG. 1, a cable 10 includes widely spaced fins 11 creating wide air channels 13. Four twisted wire pairs (A, B, C and D) are located in the cable core. FIG. 2 is the same as FIG. 1, but illustrates in broken lines the intended occupation areas (a, b, c and d) of the four twisted pairs (A, B, C and D), respectively. FIG. 2 also illustrates in a broken line (e), the intended occupation area of the entire cable core. As can be seen in FIG. 2, the intended occupation areas (a, b, c and d) of the four twisted wire pairs (A, B, C and D), and hence the occupation area (e) of the cable core, are not intended to enter into the air channels 13.

One drawback appreciated by the Applicant is that in the quest to expand the channel width, the possibility of a wire of a twisted pair entering an air channel 13 increases. The air channel 13 can be made so wide that one or both wires of a twisted pair A, B, C or D may slightly or fully enter into a channel 13. This negates the effectiveness of the finned jacket. Once a wire enters the air channel 13, the wire is closely surrounded by the insulating material of the jacket with the higher dielectric constant.

As seen in FIG. 3, it is possible for a wire 21 of the twisted pair D to fully enter into an air channel 13. The wire 21 is then closely adjacent to the jacket material. FIG. 3 also illustrates a wire 22 of the twisted pair C, which has partially entered into an air channel 13 to be proximate the jacket material. These intrusions into the air channels 13 may occur along the length of the cable 10 at various points and to varying degrees, leading to variations in signal performance along the length of the cable 10 (e.g., impedance variations).

The number of intrusions into the air channels 13 along a given length of cable 10 and the extent of the intrusions into the air channels 13 are based upon several factors, primarily including—the size of the air channels 13, whether or not a core twist is used, if a core twist is used—the core lay length, the number of bends in the cable 10 along its ultimate route, the angular extent of the bend(s) in the route of the cable 10, the pulling force applied to the cable 10 during installation, and any constant pressure on the cable jacket due to adjacent cables and other objects.

Another potential drawback is that over time, contact points (as illustrated by reference numeral 24 in FIG. 1) between the jacket material and the wire's insulation can form an adherence. This may be due to plasticization, and can depend upon the environmental surrounding, heat and pressure exposures during storage and installation, and aging. The adhesion spots 24 can be troublesome during connector termination, when stripping off the jacket. Also, the adhesion spots 24 could cause impedance variations along a length of the cable 10 and other performance issues.

It is an object of the present invention to address one or more of the drawbacks which the Applicant has appreciated in the background art.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus, are not limits of the present invention, and wherein:

FIG. 1 is a cross sectional view of a twisted pair cable with four twisted pairs, in accordance with the background art;

FIG. 2 is a cross sectional view of the twisted pair cable of FIG. 1 illustrating the boundaries of the four twisted pairs individually and as a core;

FIG. 3 is cross sectional view illustrating potential breaches into air channels by the twisted pairs in the cable of FIG. 1;

FIG. 4 is a cross sectional view of a twisted pair cable, in accordance with a first embodiment of the present invention;

FIG. 5 is a perspective view of a twisted pair cable, in accordance with a second embodiment of the present invention;

FIG. 6 is a cross sectional view taken along line VI-VI in FIG. 5;

FIG. 7 is a perspective view of a twisted pair cable, in accordance with a third embodiment of the present invention;

FIG. 8 is a perspective view of a twisted pair cable, in accordance with a fourth embodiment of the present invention; and

FIG. 9 is a cross sectional view taken along line IX-IX in FIG. 8.

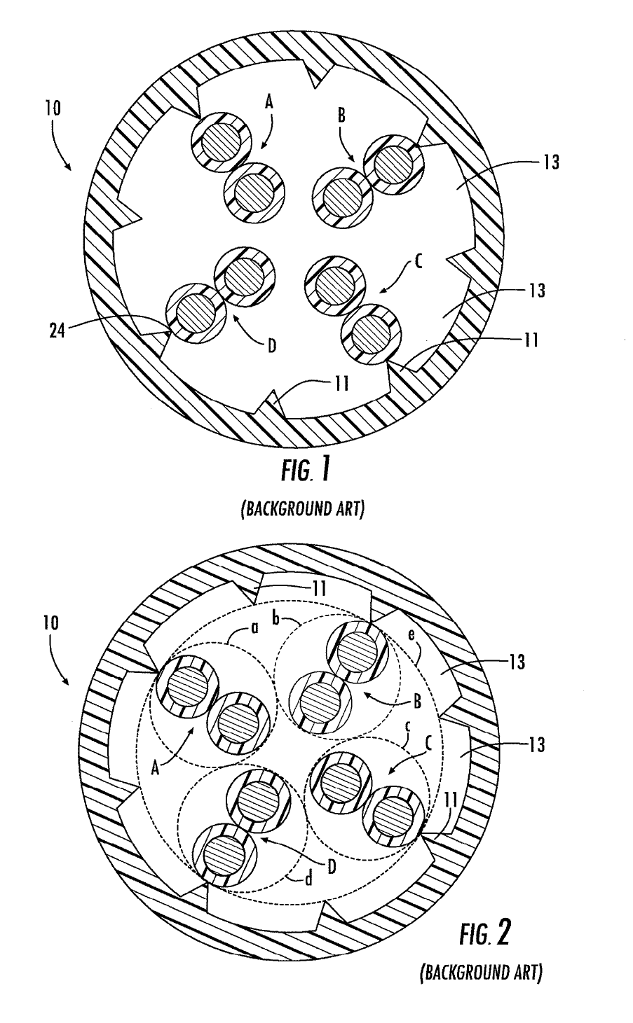

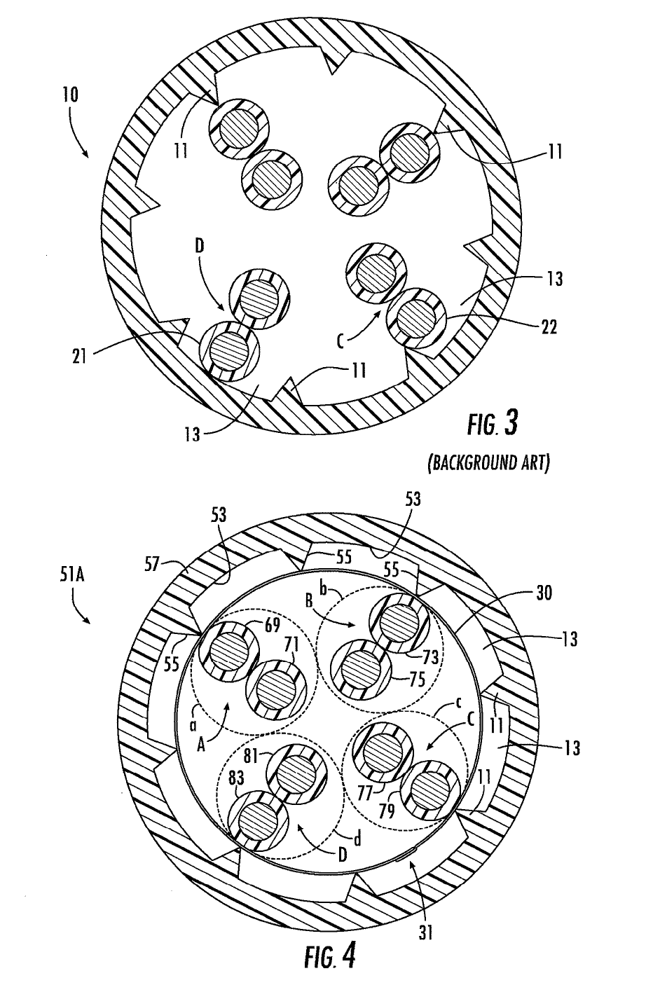

### DETAILED DESCRIPTION OF A PREFERRED EMBODIMENT

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

FIG. 4 shows a cable 51A with a jacket 57, in accordance with a first embodiment of the present invention. The jacket 57 includes a plurality of projections 55 extending away from an inner surface 53 of the jacket 57 toward a center of the cable 51A. In the first embodiment of FIG. 4, the plurality of projections 55 is formed by eight projections 55, which form eight air channels 13 around the inner surface 53 of the jacket 57. However, as illustrated in other embodiments herein, more or fewer projections 55 may be included, such as six projections, five projections or even three projections.

The jacket 57 surrounds a cable core. The cable core may include a first twisted wire pair A, a second twisted wire pair B, a third twisted wire pair C, and a fourth twisted wire pair D. The jacket 57 may be formed of polyvinylchloride (PVC), low smoke zero halogen PVC, polyethylene (PE), fluorinated ethylene propylene (FEP), polyvinylidene fluoride (PVDF), ethylene chlorotrifluoroethylene (ECTFE), or other foamed or solid materials common to the cabling art.

Each twisted wire pair A, B, C and D includes two insulated conductors. Specifically, the first twisted wire pair A includes a first insulated conductor 69 and a second insulated conductor 71. The second twisted wire pair B includes a third insulated conductor 73 and a fourth insulated conductor 75. The third twisted wire pair C includes a fifth insulated conductor 77 and a sixth insulated conductor 79. The fourth twisted wire pair D includes a seventh insulated conductor 81 and an eighth insulated conductor 83.

Each of the first through eighth insulated conductors 69, 71, 73, 75, 77, 79, 81 and 83 is constructed of an insulation layer surrounding an inner conductor. The outer insulation layer may be formed of a flexible plastic material having flame retardant and smoke suppressing properties, such as a polymer or foamed polymer, common to the cabling art like fluorinated ethylene propylene (FEP), polyethylene (PE) or polypropylene (PP). The inner conductor may be solid or stranded, and may be formed of a conductive metal or alloy, such as copper. In one embodiment, the inner conductor is a solid, copper wire of about twenty three gauge size.

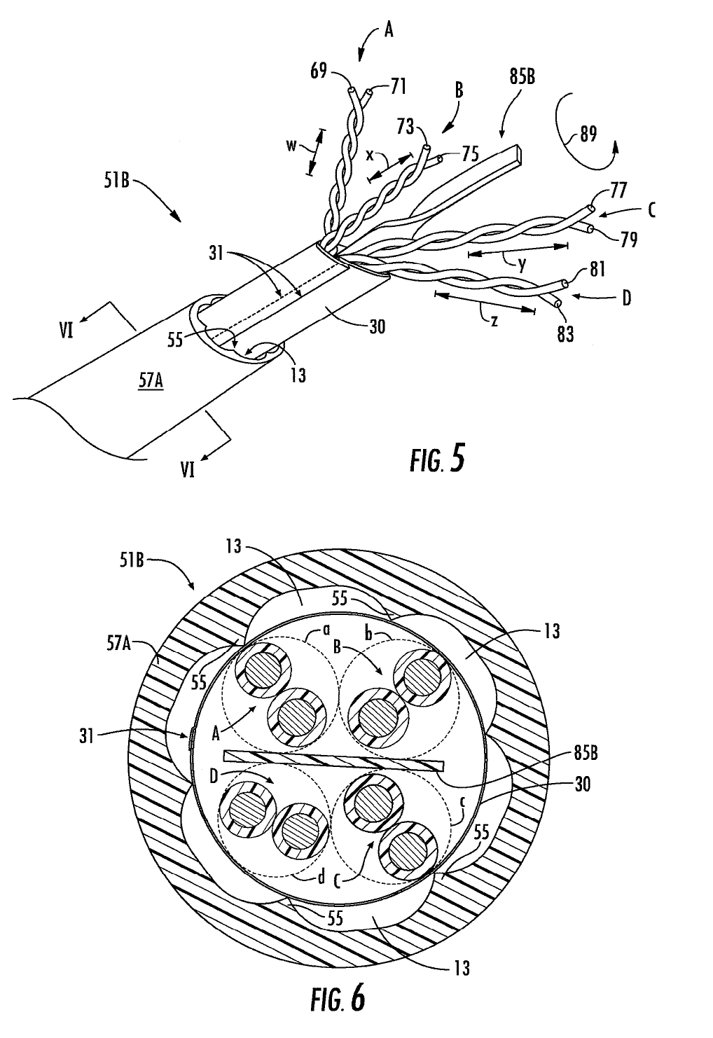

As illustrated in FIGS. 5, 7 and 8, each twisted wire pair A, B, C and D is formed by having its two insulated conductors continuously twisted around each other. For the first twisted wire pair A, the first conductor 69 and the second conductor 71 twist completely about each other, three hundred sixty degrees, at a first interval w along the length of the cable 51. The first interval w may purposefully vary within a first range of values (randomly or in accordance with an algorithm) along the length of the cable 51.

For the second twisted wire pair B, the third conductor 73 and the fourth conductor 75 twist completely about each other, three hundred sixty degrees, at a second interval x along the length of the cable 51. The second interval x may purposefully vary within a second range of values (randomly or in accordance with an algorithm) along the length of the cable 51.

For the third twisted wire pair C, the fifth conductor 77 and the sixth conductor 79 twist completely about each other, three hundred sixty degrees, at a third interval y along the length of the cable 51. The third interval y may purposefully vary within a third range of values (randomly or in accordance with an algorithm) along the length of the cable 51.

For the fourth twisted wire pair D, the seventh conductor 81 and the eighth conductor 83 twist completely about each other, three hundred sixty degrees, at a fourth interval z along the length of the cable 51. The fourth interval z may purposefully vary within a fourth range of values (randomly or in accordance with an algorithm) along the length of the cable 51.

Each of the twisted wire pairs A, B, C and D has a respective first, second, third and fourth mean value within the respective first, second, third and fourth ranges of values. Each of the first, second, third and fourth mean values of the intervals of twist w, x, y and z may be unique, e.g., different from the other three values. More information about the above-described twist modulation can be found in the Assignee's U.S. Pat. No. 6,875,928 and published U.S. Application 2008/0073106, which are incorporated herein by reference.

As illustrated in FIGS. 7-9, the first through fourth twisted wire pairs A, B, C and D may be separated from each other by a star-shaped or plus-shaped separator 85A (sometimes referred to as a flute, isolator or cross-web), and may be twisted together with the separator 85A in a direction 89 to form a stranded core. The core strand direction 89 may be opposite to the pair twist directions of the first through fourth twisted wire pairs A, B, C and D, however this is not a necessary feature.

In preferred embodiments, the strand length of the core is about five inches or less, more preferably about four inches or less. In a more preferred embodiment, the core strand-length is purposefully varied, or modulates, from an average strand length along a length of the cable 51. Core strand modulation can assist in the reduction of alien crosstalk. For example, the core strand length could modulate between two inches and four inches along the length of the cable 51, with an average value of three inches.

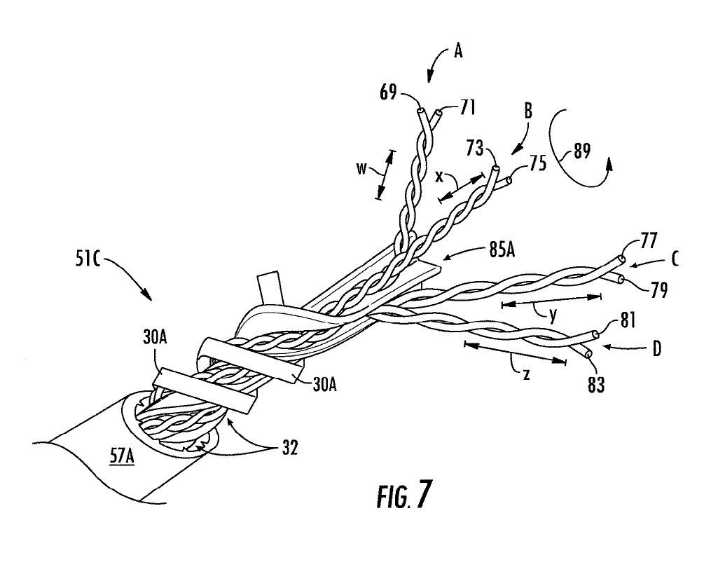

Other sizes and shapes of separators may be employed in combination with the present invention, such as a generally flat tape separator 85B (which separates two twisted wire pairs from the other two twisted wire pairs, as depicted in FIGS. 5-6). The separator 85A or 85B may be formed of any solid or foamed material common to the cabling art, such as a polyolefin or fluoropolymer, like polyethylene (PE) or fluorinated ethylene propylene (FEP).

The cable 51A of the first embodiment of the invention has eight projections 55 forming eight air channels 13. The cable 51A of the first embodiment has no separator 85A or 85B. The cable 51B of the second embodiment of the invention has a jacket 57A with six projections 55 forming six air channels 13. The cable 51B of the second embodiment has a generally flat tape separator 85B.

The cables 51A and 51B of the first and second embodiments both include an identical core wrap 30. The core wrap 30 at least partially surrounds the cable core. In the depicted first and second embodiments, the core wrap 30 is formed by a sheet of material with a length as long as the cable 51A or 51B, a width which is slightly larger than a circumference of the cable core (to permit an overlap), such that the core wrap 30 completely surrounds the cable core along a length of the cable 51A or 51B. Hence, the core wrap 30 abuts the plurality of projections 55 of the jacket 57 and 57A. The wires of the twisted wire pairs A, B, C and D are prevented from contacting the plurality of projections 55 and also prevent from entering into an air channel 13.

The core wrap 30 may include an adhesive layer and may partially overlap itself at an overlap area 31. The overlapped portions of the core wrap 30 may be adhered to each other by the adhesive layer. The adhesive layers may be applied to the entire inner surface of the core wrap 30 facing the center of the cable 51A or SIB. Alternatively, the adhesive layer may be applied to just a strip of the core wrap 30 adjacent to the edge of the core wrap 30 where the overlap area 31 occurs. In a preferred embodiment, the adhesive layer creates a substantially air tight connection between the overlapped portions of the core wrap 30. Instead of an adhesive layer, the core wrap 30 may be heated, such that the material forming the core wrap 30 adheres to itself in the overlap area 31.

In a preferred embodiment, the core wrap 30 is formed of a polyester material (like MYLAR) or a similar non-conductive material. In a preferred embodiment, the core wrap 30 has a thickness of about 0.8 mils or less, although other thicknesses are possible.

FIG. 7 is a perspective view of a cable 51C in accordance with a third embodiment of the present invention. The cable 51C of the third embodiment of the invention has the jacket 57A with six projections 55 forming six air channels 13. The cable 51B of the third embodiment has the plus-shaped separator 85A.

The cable 51C of the third embodiment includes a core wrap 30A which only partially surrounds the cable core, leaving an air gap 32 along the length of the cable 51C. The core wrap 30A is formed by a tape traveling around the cable core in an open helix shape. In the depicted embodiment, the tape would have a length much greater than a length of the cable 51C and a width which is about 0.2 inches. The core wrap 30A is helically wrapped about the cable core at an angle of about thirty degrees, which creates a helical air gap 32 of about 0.4 inches along the length of the cable 51B. Of course, different tape widths and angles of helical winding may be employed so as to change the dimensions of the air gap 32. The core wrap 30A will assist in keeping the cable core tight and keeping wires of the cable core out of the air channels 13.

The core wrap 30A may optionally include an adhesive layer on its surface facing the cable core to adhere the core wrap 30A to the insulation layers of the twisted wire pairs A, B, C and D and/or the edges of the separator 85A or 85B. Instead of an adhesive layer, the core wrap 30A may be heated, such that the material forming the core wrap 30A adheres itself to the insulation layers of the twisted wire pairs A, B, C and D and/or the edges of the separator 85A or 85B. In a preferred embodiment, the core wrap 30A is formed of a polyester material (like MYLAR) or a similar non-conductive material. In a preferred embodiment, the core wrap 30A has a thickness of about 0.8 mils or less, although other thicknesses are possible.

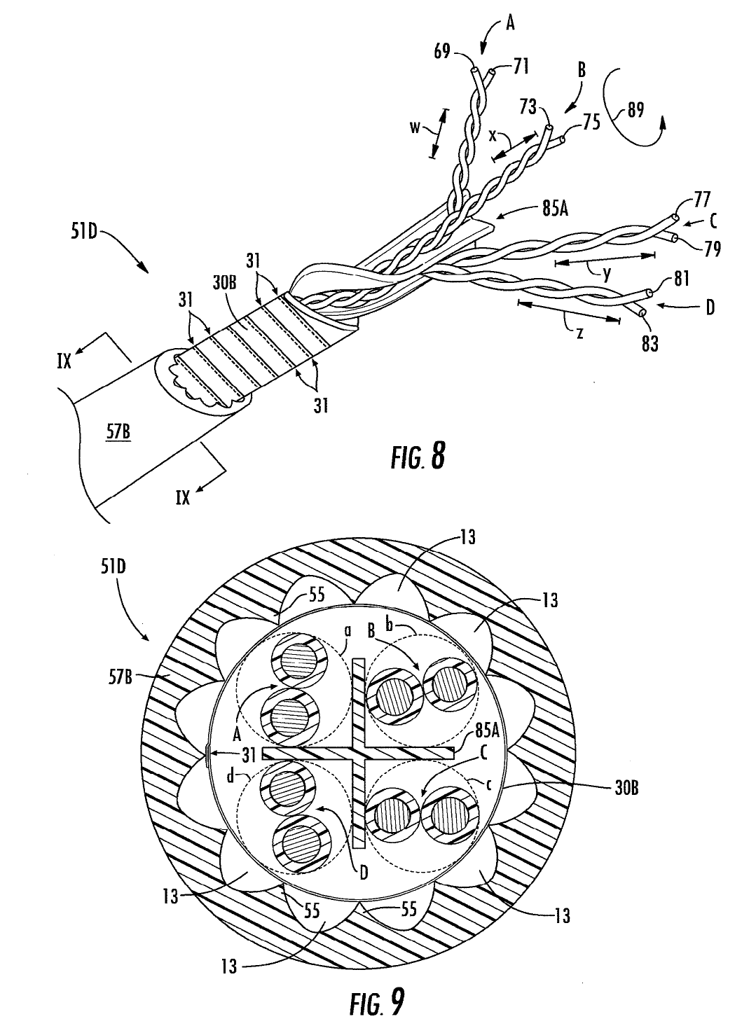

FIG. 8 is a perspective view of a cable 51D in accordance with a fourth embodiment of the present invention. FIG. 9 is a cross sectional view taken along line IX-IX in FIG. 8. The cable 51D of the fourth embodiment of the invention has a jacket 57B with twelve projections 55 forming twelve air channels 13. The cable 51D of the fourth embodiment has the plus-shaped separator 85A.

The cable 51D of the fourth embodiment includes a core wrap 30B which completely surrounds the cable core along the length of the cable 51D. The core wrap 30B is formed by a tape traveling around the cable core in an overlapping helix shape. In the depicted embodiment, the tape would have a length much greater than a length of the cable 51D and a width which is about 0.2 inches. The core wrap 30B is helically wrapped about the cable core at an angle of about 5 to 10 degrees, which creates a continuous helically-shaped, small overlapped area 31 with the previous helical wrap. Of course, different tape widths and angles of helical winding may be employed so as to change the extent of the overlapped area 31.

The core wrap 30B may optionally include an adhesive layer on its surface facing the cable core to adhere the core wrap 30B to the insulation layers of the twisted wire pairs A, B, C and D and/or the edges of the separator 85A or 85B. Alternatively, the adhesive layer may be applied to just a strip of the core wrap 30B adjacent to the edge of the core wrap 30B where the overlap area 31 occurs. In a preferred embodiment, the adhesive layer creates a substantially air tight connection between the overlapped portions of the core wrap 30B. Instead of an adhesive layer, the core wrap 30B may be heated, such that the material forming the core wrap 30B adheres to itself in the overlap area 31.

In a preferred embodiment, the core wrap 30B is formed of a polyester material (like MYLAR) or a similar non-conductive material. In a preferred embodiment, the core wrap 30B has a thickness of about 0.8 mils or less, although other thicknesses are possible.

With the core wraps 30, 30A and 30B, the air channels 13 may be made very large in width, yet the risk of a wire of a twisted wire pair A, B, C, D entering one of the air channels 13 is greatly diminished. For example, the width of each air channel 13 may be greater than a diameter of a wire of a twisted wire pair of the cable core. More preferably, the width of each air channel 13 may be greater than twice the diameter of a wire of a twisted wire pair of the cable core.

Although the cables illustrated in the drawing figures have included four twisted wire pairs, it should be appreciated that the present invention is not limited to cables having only four twisted wire pairs. Cables having other numbers of twisted wire pairs, such as one twisted wire pair, two twisted wire pairs or even twenty-five twisted wire pairs, could benefit from the structures disclosed in the present invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

I claim:

1. A cable comprising:
a jacket having a plurality of projections extending away from an inner surface of said jacket;
a cable core including at least one twisted wire pair located, within said jacket; and
a core wrap at least partially surrounding said cable core, such that said core wrap abuts said plurality of projections of said jacket.

2. The cable according to claim 1, wherein said plurality of projections is eight or less projections, creating eight or less air channels surrounding said cable core.

3. The cable according to claim 1, wherein said plurality of projections is six or less projections, creating six or less air channels surrounding said cable core.

4. The cable according to claim 1, wherein said core wrap includes an adhesive layer, wherein said core wrap partially overlaps itself, and wherein overlapped portions of said core wrap are adhered to each other by said adhesive layer.

5. The cable according to claim 4, wherein said overlapped portions of said core wrap form a substantially air tight connection.

6. The cable according to claim 1, wherein said core wrap includes a tape traveling around said cable core in a helix shape.

7. The cable according to claim 6, wherein said tape partially overlaps itself in forming said helix shape.

8. The cable according to claim 7, wherein said tape includes an adhesive layer, and wherein overlapped portions of said tape are attached to each other via said adhesive layer to form a substantially air tight connection.

9. The cable according to claim 1, wherein said core wrap is formed of a polyester material.

10. The cable according to claim 1, wherein said core wrap has a thickness of about 0.8 mils or less.

11. The cable according to claim 1, wherein said at least one twisted wire pair includes a first twisted wire pair, a second twisted wire pair, a third twisted wire pair and a fourth twisted wire pair, and wherein said cable core further includes a separator separating said first twisted wire pair from at least one of said second twisted wire pair, said third twisted wire pair and said fourth twisted wire pair.

12. The cable according to claim 11, wherein said cable core is twisted to form a stranded core.

13. A cable comprising:
a jacket having a plurality of projections extending away from an inner surface of said jacket;
a cable core including a first twisted wire pair, a second twisted wire pair, a third twisted wire pair, a fourth twisted wire pair and a separator, wherein said separator separates said first twisted wire pair from at least one of said second twisted wire pair, said third twisted wire pair and said fourth twisted wire pair; and
a core wrap completely surrounding said cable core along a length of said cable, such that said core wrap abuts said plurality of projections of said jacket.

14. The cable according to claim 13, wherein said core wrap is formed by a tape traveling around said cable core in a helix shape, wherein said tape partially overlaps itself in forming said helix shape.

15. The cable according to claim 14, wherein said tape includes an adhesive layer, and wherein overlapped portions of said tape are attached to each other via said adhesive layer.

16. The cable according to claim 15, wherein said cable core is twisted to form a stranded core.

17. A cable comprising:
a jacket having a plurality of air channels formed around an inner surface of said jacket;
a cable core located within said jacket, wherein said core includes at least one twisted wire pair; and
a core wrap at least partially surrounding said cable core, such that said core wrap prevents any wire of said cable core from entering into one of said plurality of air channels.

18. The cable according to claim 17, wherein said plurality of air channels is six or less air channels.

19. The cable according to claim 17, wherein said core wrap includes an adhesive layer, wherein said core wrap partially overlaps itself, and wherein overlapped portions of said core wrap are adhered to each other by said adhesive layer.

20. The cable according to claim 17, wherein said core wrap is formed by a tape traveling around said cable core in a helix shape, wherein said tape partially overlaps itself in forming said helix shape, wherein said tape includes an adhesive layer, and wherein overlapped portions of said tape are attached to each other via said adhesive layer.
